(19) United States
(12) Patent Application Publication
(10) Pub. No.: US 2026/0237538 A1
(43) Pub. Date: Aug. 13, 2026

(54) Method for the Production of Conductive Structures or Layers

(71) Applicant: INM - Leibniz-Institut für Neue Materialien gemeinnützige GmbH, Saarbrücken (DE)

(72) Inventors: Peter König, Lebach (DE); Peter William de Oliveira, Folking (FR)

(73) Assignee: INM - Leibniz-Institut für Neue Materialien gemeinnützige GmbH, Saarbrücken (DE)

(21) Appl. No.: 19/155,281

(22) PCT Filed: Feb. 9, 2024
(86) PCT No.: PCT/EP2024/053351

§ 371 Date: Aug. 11, 2025

(30) Foreign Application Priority Data
Feb. 16, 2023 (DE) 10 2023 103 785.4

(51) Int. Cl. H01B 1/22; H01B 1/02

(52) U.S. Cl. CPC H01B 1/22; H01B 1/02

(57) ABSTRACT

A composition comprising at least one reducing agent and at least one metal complex is applied as nanofibers, in particular by electrospinning, or in a surface manner to a substrate. The metal complex is then reduced to the metal by the reducing agent and heating and/or exposure to electromagnetic radiation.

### FIELD OF THE INVENTION

The invention relates to a process for the production of metallic, in particular conductive structures or surfaces, as well as compositions for their production, such conductive structures or surfaces and their use.

### STATE OF THE ART

Fibers obtained by electrospinning have a very high aspect ratio. This is advantageous for applications that require a large surface area with a small volume. For example, TiO₂ nanofibers coated with silver nanoparticles have been used for surface enhanced Raman spectroscopy, antibacterial coatings, photocatalysis and energy conversion. Conductive nanofibers have also been proposed as electrodes or for touchscreens.

For fibers made of conductive materials, fibers made of conductive polymers or other conductive materials such as metals or graphene are known.

Another possibility is inks that contain a metal compound in addition to a polymer and sometimes also a reducing agent. This is described, for example, in US 2017/0077403 A1. Some of the inks described there are thermally reduced, although contrary to the information provided, high temperatures are always used. For example, an ink containing PEO and PVP is described. Silver acetate is used as the silver source and formic acid as the reducing agent. The composition is spun onto glass and briefly heat-treated at 300° C. and above.

The processes are not suitable for production on film substrates such as polycarbonate or PET, particularly due to the high temperatures involved. They also often involve several steps.

### Problem

The object of the invention is to provide a method which allows the production of metallic structures based on nanofibers or conductive surfaces, in particular transparent conductive structures.

### Solution

This task is solved by the inventions with the features of the independent claims. Advantageous further embodiments of the inventions are characterized in the dependent claims. The wording of all claims is hereby made the content of this description by reference. The inventions also comprise all useful and in particular all mentioned combinations of independent and/or dependent claims.

The problem is solved by a process for the production of metallic structures and/or surfaces.

In the following, individual process steps are described in more detail. The steps do not necessarily have to be carried out in the order indicated, and the method to be described may also comprise further steps that are not mentioned. The method comprises the following steps:
a) Providing a composition comprising at least one metal complex or a precursor thereof, at least one reducing agent, at least one matrix material or at least one precursor thereof;
b) Application of the composition to a substrate, whereby the application is carried out by surface contacting or application as a spun nanofiber;
c) Reduction of the at least one metal complex to the metallic structure or surface by exposure to electromagnetic radiation and/or heating.

In step c), a metal layer or layer of metallic fibers is usually formed, depending on the method of application. In this context, a metallic layer in the sense of the invention is understood to be a layer of a metal. Such layers can also be conductive if they are sufficiently thick. Such conductive layers are particularly preferred. Conductive does not necessarily mean the production of structures, which in themselves represent a conductor path. The production of dots from conductive material also rep-resents a conductive structure in principle. In the case of fibers, several layers of fibers can also be applied.

The composition comprises at least one metal complex. This comprises at least one metal ion and at least one type of ligand. The metal ion is, for example, an ion of copper, silver, gold, nickel, zinc, aluminum, titanium, chromium, manganese, tungsten, platinum or palladium. In a preferred embodiment, the metal complex is a silver, gold or copper complex, particularly preferably a silver complex. The composition may also comprise several types of metal complexes or mixtures of metal complexes.

Chelate ligands are generally used as ligands. These are able to form particularly stable complexes. These are compounds which have several hydroxyl groups and/or amino groups. Preferred are compounds with a molecular weight of less than 200 g/mol, particularly preferred are compounds with at least one hydroxyl group and at least one amino group. Examples of possible compounds are 3-amino-1,2-propanediol, 2-amino-1-ethan-1-ol (ethanolamine), 2-amino-1-propan-1-ol, 3-amino-1-propan-1-ol, 2-amino-1-butanol, tris(hydroxymethyl)-aminomethane (TRIS), NH₃, nicotin-amide or 6-aminohexanoic acid. Mixtures of these ligands can also be used.

In the case of the preferred silver complex, ethanolamine or NH₃ is the preferred ligand.

It may be necessary, especially when using NH₃, to add an alkaline compound, such as a hydroxide like NaOH, KOH and/or tetra-methylammonium hydroxide. This is particularly preferred when silver salts are used.

Ligands with amino groups or amino and hydroxyl groups are preferred, which can serve as reducing agents for the metal complex under the conditions of step c). In this preferred case, the metal complex of the composition is formed from the reducing agent and a metal salt. If the reducing agent is used in excess, the metal complex and also free reducing agent are therefore present in the composition. The composition then preferably contains no further reducing agent.

In a preferred embodiment, the molar ratio of ligand, based on the amino groups or NH₃, and metal salt is at least 1.2:1, preferably at least 1.5:1, in particular 1.2:1 to 10:1, particularly preferably 1.5:1 to 10:1. The excess ligand complexes and dis-solves the metal salt, as well as subsequently reducing it. The ligand also supports the reduction reaction if a photocatalytic substrate is used.

The metal complex is preferably formed in the composition from at least one metal salt and at least one ligand, preferably at least one metal salt and the reducing agent as ligand. The complex is preferably formed in situ in the composition.

The metal salt is preferably selected from salts of copper, silver, gold, nickel, zinc, aluminum, titanium, chromium, manganese, tungsten, platinum or palladium, preferably silver, gold or copper, particularly preferably a silver salt.

The salt is preferably selected from fluorides, chlorides, bromides, iodides, nitrates, nitrites, sulphates or acetates. Preferred are salts which are soluble in the composition. Nitrates and acetates are preferred. Silver nitrate and silver acetate are particularly preferred.

Preferably, the at least one metal complex is dissolved in the composition.

The composition further comprises at least one matrix material or at least one precursor thereof. This may be an organic, an inorganic or organically modified inorganic matrix-forming material. In particular, these may be inorganic brines or organically modified inorganic hybrid materials. Examples of this may be organically modified oxides, hydrolysates and (poly)condensates of at least one glass- or ceramic-forming element M, in particular an element M from groups 3 to 5 and/or 12 to 15 of the periodic table of elements, preferably Si, Al, B, Ge, Pb, Sn, Ti, Zr, V and Zn or mixtures thereof. Elements of groups 1 and 2 of the periodic table (e.g. Na, K, Ca and Mg) and groups 5 to 10 of the periodic table (e.g. Mn, Cr, Fe and Ni) or lanthanides may also be present in the oxide, hydrolysate or (poly) condensate. For example, it may be a sol comprising Ti, which may also be the precursor of the photocatalytically active component.

In the case of an organic matrix material, organic polymers and/or oligomers, preferably organic polymers and/or oligomers which have polar groups, such as hydroxyl, primary, secondary or tertiary amino, carboxyl or carboxylate groups, can be used. Typical examples are polyvinyl alcohol, polyethylene oxide (PEO), polyvinyl pyrrolidone, polyacrylamide, polyvinyl pyri-dine, polyallylamine, polyacrylic acid, polyvinyl acetate such as polyvinyl butyral, polymethyl methacrylic acid, starch, gum arabic, other polymeric alcohols such as polyethylene-polyvinyl alcohol copolymers, polyethylene glycol, polypropylene glycol and poly(4-vinylphenol) or monomers or oligomers derived therefrom. Preferred are polyethylene oxide or polyvinyl pyrollidone (PVP).

Preferred are organic polymers with a molecular mass of more than 200000 g/mol (weight average M_{w}) to 6000000 g/mol, preferably from more than 1000000 g/mol to 4500000 g/mol.

The composition may also contain at least one solvent. All components must be soluble or dispersible in the solvent. These may be, for example, alcohols such as methanol, ethanol or n-propanol, i-propanol, or water. Preferred is/are one or more solvents with a boiling point of below 150° C., in particular below 101° C. Particularly preferably, the solvent comprises at least water. Mixtures of the solvents can also be used, preferably mixtures of water and ethanol. A ratio of 50:50 wt. % to 20:80 wt. % of H₂O:alcohol, preferably ethanol, is suitable as a mixing ratio. Water is particularly preferred as the only solvent.

Other additives may also be present, such as surface-active agents, antioxidants or plasticizers. Preferably no additives are present.

The viscosity of the composition can be adjusted according to the method of application.

Depending on the composition, the content of matrix component in the case of an organic matrix component is preferably between 0.1 and 10% by weight of the composition, in particular between 0.1 and 5% by weight.

The content of metal complex and ligand may vary depending on the application.

It may be necessary to mix the composition for 1 hour to 72 hours prior to electrospinning, especially if the composition comprises hydrolyzable compounds.

The preferred conditions for electrospinning are a voltage of 8 to 20 kV at a flow rate of the spinning mass of 0.3 to 1.5 mL/h. The distance to the surface on which the fibers are collected is preferably 10 to 30 cm. Preferably, a needle with an inner diameter of 0.1 mm to 2 mm is used.

Alternatively, the composition can be applied to the surface of a substrate. Conventional methods can be used to apply the composition, for example dipping, rolling, squeegeeing, flooding, drawing, spraying, spinning or brushing.

It can also be applied several times in succession.

In the next step, the at least one metal complex is reduced to a metallic structure or surface by exposure to electromagnetic radiation and/or heating.

Due to the reducing agent present, this can be done under mild conditions. The conditions can be adapted to the substrate.

The reduction can also take place in several steps, in which the irradiation and/or heating is repeated.

In the case of heating, heating to below 200° C., preferably 50° C. to 150° C., is preferred.

Heating is preferably carried out for at least 6 hours, preferably 6 to 36 hours.

Heating is preferably carried out in an ambient atmosphere.

In one embodiment of the invention, the composition is applied to a photocatalytically active coated substrate. Preferably, the substrate is coated with at least one layer of titanium dioxide which is photocatalytically active. This can be amorphous titanium dioxide, anatase or rutile, as well as mixtures thereof. The titanium dioxide can also be doped, for example with indium. It is only important that it is photocatalytically active under the conditions required to reduce the metal complex.

Electromagnetic radiation is radiation of the wavelength required to excite the photocatalytic component. The irradiation can be carried out by using a surface radiation source, such as a lamp, or by laser. Preferably, a wavelength in the visible or ultraviolet (UV) range of the electromagnetic spectrum is used, preferably radiation with a wavelength of <500 nm, for example between 200 and 450 nm or between 250 nm and 410 nm. Preferred is radiation with a wavelength of <400 nm.

Any suitable light source can be used as a light source. Examples of a light source are mercury vapor lamps or xenon lamps.

The light source is positioned at a suitable distance from the substrate to be exposed. The distance can be between 2.5 cm and 50 cm, for example. The intensity of the radiation can be between 30 mW/cm² and 70 mW/cm² in a spectral range of 250 nm to 410 nm.

The irradiation should be as perpendicular as possible to the surface to be exposed.

The irradiation is carried out for the duration required to form the metallic layer or structure. The duration depends on the substrate, the composition, the type of lamp, the wavelength range used and the intensity of the irradiation. If conductive structures are to be produced, longer irradiation may be necessary. The preferred duration of irradiation is between 5 seconds and 30 minutes, preferably between 20 seconds and 15 minutes.

If a laser is used for irradiation, an argon ion laser (351 nm) with 10 mW can be used, for example, whose laser beam is focused and collimated and guided at a speed of 2 mm/s over the substrate to be irradiated.

The substrate to which the composition is applied may be any material suitable for this purpose. Examples of suitable materials are metals or metal alloys, glass, ceramics, including oxide ceramics, glass-ceramics or plastics, as well as paper and other cellulose-containing materials. Of course, substrates that have a surface layer of the aforementioned materials can also be used. The surface layer can, for example, be a metallization, an enamel coating, a glass or ceramic layer or a varnishing.

Examples of metals or metal alloys are steel, including stain-less steel, chromium, copper, titanium, tin, zinc, brass and aluminum. Examples of glass are soda lime glass, borosilicate glass, lead crystal and silica glass. It can be e.g. flat glass, hollow glass such as container glass, or laboratory equipment glass. The ceramic is, for example, a ceramic based on the oxides SiO₂, Al₂O₃, Zro₂ or MgO or the corresponding mixed oxides. Examples of the plastic, which, like the metal, can be present as a film, are polyethylene, e.g. HDPE or LDPE, polypropylene, polyisobutylene, polystyrene (PS), polyvinyl chloride (PVC), polyvinylidene chloride, polyvinyl butyral, polytetrafluoroethylene, polychlorotrifluoroethylene, polyacrylates, polymethacrylates such as polymethyl methacrylate (PMMA), polyamide, polyethylene terephthalate (PET), polycarbonate, regenerated cellulose, cellulose nitrate, cellulose acetate, cellulose acetriacetate (TAC), cellulose acetate butyrate or rubber hydrochloride. A lacquered surface can be formed from conventional base coats or lacquers. In a preferred embodiment, the substrates are films, in particular polyethylene terephthalate films or polyimide films. If the structures are already manufactured on the surface, the surface must be able to withstand the manufacturing conditions, such as the temperatures.

By reducing the nanofibers, the metallic structures can be formed according to the fibers, making thinner conductive structures possible. The reducing agent in the composition ensures that the reduction is selective. Since the composition itself is not, or only to a small extent, light-sensitive, it can be handled much more easily. The metallic, preferably conductive, structure is also transparent due to the thinness of the nanofibers.

The composition itself does not contain any photocatalytically active components such as titanium dioxide or ZnO.

Preferably, the nanofibers have an average length of more than 10 μm, in particular more than 20 μm, especially preferably more than 50 μm.

In a preferred embodiment of the invention, the nanofibers are obtained by electrospinning.

For this purpose, a composition comprising at least one metal complex, at least one reducing agent, at least one matrix material or a precursor is prepared.

This is spun into a nanofiber using electrospinning.

Several layers of nanofibers can also be applied to the substrate. The application is carried out until the desired quantity and density of nanofibers has been applied to the substrate.

It may be necessary to treat the fibers, for example to dry them, for example at temperatures below 200° C., in particular below 150° C. These low temperatures allow the use of sensitive substrates such as films, especially plastic films.

It may be necessary to allow the fibers to rest for at least 12 hours immediately after electrospinning before further processing.

It may be necessary to apply the nanofibers to the final substrate.

Preferably, the nanofibers after electrospinning have an average diameter of less than 1 μm, in particular less than 500 nm (determined with ESEM), in particular less than 400 nm. Preferably, the fibers have a round cross-section. The diameter is preferably between 30 nm and 500 nm, in particular between 50 and 350 nm.

It may be necessary to mix the composition for 1 hour to 72 hours before electrospinning.

The preferred conditions for electrospinning are a voltage of 8 to 20 KV at a flow rate of the spinning mass of 0.3 to 1.5 mL/h. The distance to the surface on which the fibers are collected is preferably 5 to 30 cm. Preferably, a needle with an inner diameter of 0.2 mm to 2 mm is used.

In a further embodiment of the invention, the substrate is further treated after the reduction of the composition. For example, the surface may be cleaned by rinsing the surface, for example with deionized water or another suitable substance. The coated substrate may then be dried, for example by heating in an oven, compressed air and/or by drying at room temperature.

It can also be irradiated several times, for example 2, 3 or 4 times.

In a preferred embodiment, the coated substrate is treated with plasma after reduction, preferably an Ar plasma. The treatment can last between 30 seconds and 30 minutes. An Ar plasma is preferred.

Additional layers can also be applied, for example to protect the coated surface from oxidation and water or from UV radiation.

In one embodiment of the invention, structuring takes place during application of the composition and/or during reduction. In the context of the invention, this is understood to mean preparation of the spatially limited generation of the metallic structure. This is possible in different ways. On the one hand, the substrate can be coated with the composition, for example with the nanofibers, only in certain areas. It is also possible to apply the composition only to certain areas. Furthermore, the effect of the electromagnetic radiation can of course also be limited to certain areas. These methods can of course also be used in combination. For example, it is possible to apply the composition over a large area and then expose it through a mask. It is of course also possible to apply the composition selectively and then expose it over a large area.

When using electrospinning, it is also possible to apply the spun fibers to a structured substrate, in particular a substrate with elongated indentations. Due to their length, the fibers arrange themselves along the indentations.

Additional layers can also be applied after the process, for example to protect the coated surface of the substrate against UV radiation.

There are actually no restrictions on the structures applied by structuring. For example, connected structures such as conductor tracks can be applied. It is also possible to apply dot-shaped structures. Due to the good resolution, it is possible to apply conductive dots to a film that are invisible to the eye. This plays a major role in the production of surfaces for touch screens.

The invention also relates to a coated substrate obtained by a method according to the invention. Such a substrate is preferably characterized by a layer comprising metallic nanofibers. This layer has a thickness of between 50 nm and 200 μm. Preferred layer thicknesses are between 100 nm and 1 μm, preferably 50 nm to 700 nm.

The coating on the substrate is particularly preferably conductive. This is understood to mean a structure which, at a distance of 5 mm, has a resistance in at least one direction of less than 3 MΩ, preferably less than 2MΩ, most preferably less than 1 MΩ. Due to the fibrous structure, the manufactured structures can have an anisotropic resistance. This means that the resistance increases depending on the direction of the measurement by at least a factor of 2, at least a factor of 10, in particular a factor of 100.

In a particularly advantageous embodiment of the invention, the coating on the substrate is at least partially transparent, in particular completely transparent. This can be achieved by the degree of coverage of the fibers after electrospinning in the coated areas on the surface of the substrate being less than 20% of the coated surface of the substrate, in particular between 10-20%, preferably between 10 and 15%. This can be influenced, for example, by the duration of electrospinning. The coverage can be determined by measuring the average transmission and haze as a function of the duration of electrospinning.

Preferably, coating with fibers only reduces the average transmission by up to 5%.

In a further development of the invention, the metallic structure has a structuring with structural elements with an extension of less than 50 μm, preferably less than 10 μm. The structural elements may be metallic and/or non-metallic regions. The metallic structure is particularly preferably made of metallic nanofibers.

In a particularly advantageous further development of the invention, the coated substrate has metallic structures that are at least partially transparent. This can be achieved at for example by applying structures with a resolution of less than 20 μm to a transparent substrate, preferably less than 10 μm.

The compositions or fibers according to the invention reduce themselves to conductive coatings without the need to apply further compositions. This makes it easy to obtain conductive and, in particular, transparent coatings.

The coated substrates obtained by the process according to the invention can be used for many applications.

On the one hand, the process is suitable for applying reflective metal layers to surfaces. These can be used as reflective layers in holographic applications, for example.

A particular advantage of the invention lies in the production of conductive structures. These are suitable as conductor tracks in electronic applications, in particular in touch screen displays, solar collectors, displays, as RFID antennas or in transistors. In particular, transparent structures and structures with anisotropic resistance can be obtained.

However, the structures can also be used in the area of transistors.

Further details and features can be found in the following description of preferred embodiments in conjunction with the sub-claims. Here, the respective features can be realized individually or in combination with one another. The possibilities for solving the problem are not limited to the embodiment examples. For example, range specifications always include all intermediate values—not mentioned—and all conceivable subintervals.

The embodiments are shown schematically in the figures. Identical reference numerals in the individual figures denote identical or functionally identical elements or elements that correspond to each other in terms of their functions. In detail:

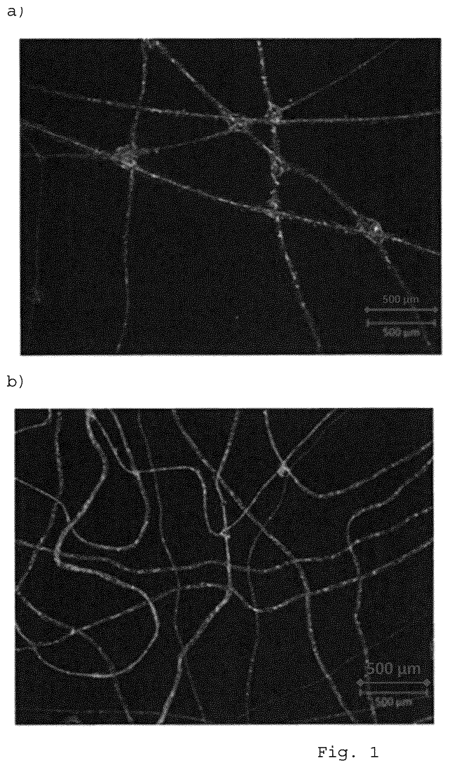

FIG. 1 Light microscope images of the spun fibers with ink 1 on a) glass or b) PC film;

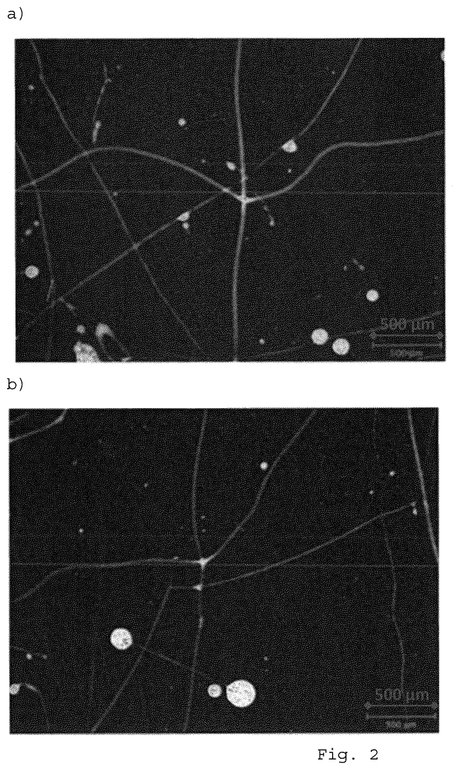

FIG. 2 Light microscope images (a) and b) of the spun fibers with ink 2 on TiO₂-coated PET film;

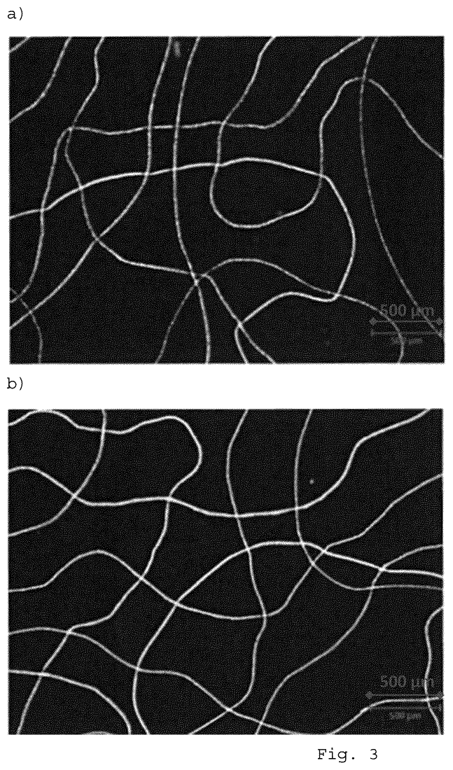

FIGS. 3a) and b): Light microscope images of the spun fibers with ink 5;

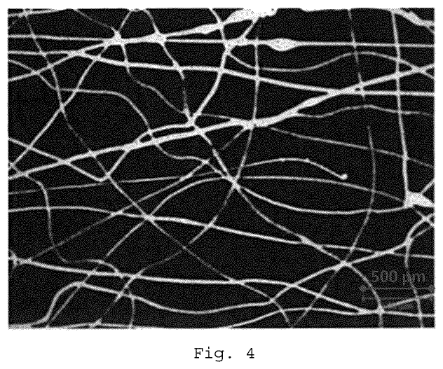

FIG. 4 Light microscope image of the spun fibers with ink 5.

### EXAMPLES

### Composition of the Inks

### Ink 1:

A composition of 0.8 g silver acetate, 0.627 g ethanolamine and 1.404 g polyethylene oxide solution (PEO, 1 wt. % in H₂O, approx. 4,000,000 g/mol) was prepared.

The composition was electrospun (temperature 23.7° C.; relative humidity 40%, Y-axis speed: 150 mm/s, X-axis pitch: 10 mm, pump rate 0.3 mL/h; needle/collector distance: 5 cm; voltage 10 kV, cannula (needle) diameter 0.3 mm). Display glass (rubbed with ethanol) or polycarbonate film (PC, Makrofol DE 1-1CG) was used as the substrate. After spinning, the film was dried at 130° C. overnight (18 h) in a convection oven. The coated PC film was treated in the MHz-Ar plasma for 10 minutes after the oven. The results are shown in Table 1 and FIGS. 1a) and b).

### Ink 2:

A composition of 0.8 g silver acetate, 0.734 g ethanolamine and 1.689 g polyethylene oxide solution (PEO, 1 wt. % in H₂O, approx. 4,000,000 g/mol) was prepared.

The composition was electrospun (temperature 23.0° C.; relative humidity 40%, Y-axis speed: 150 mm/s, X-axis pitch: 10 mm, pump rate 0.3 mL/h; needle/collector distance: 5 cm; voltage 10 kV, cannula diameter 0.3 mm). Cosmoshine PET film (11×11 cm) with TiO₂ coating (3%, 0.5 m/min, 120° C.) was used as the substrate. The coated substrate was then exposed to UV light on the Beltron UV dryer and then dried overnight at 130° C. in a convection oven. The results are shown in Table 2 and FIG. 2.

### Ink 3:

A composition was prepared from 0.798 g silver acetate, 0.605 g polyethylene oxide solution (PEO, 2% by weight in H₂O, approx. 4,000,000 g/mol), 1.216 g 30% ammonia in water, 30 mg tetramethylammonium hydroxide or potassium hydroxide.

The composition was spun onto PC film with 5 mm spacing. After heating to 130° C. overnight, individual conductive fibers were present. Coated on PC or glass, after heating to 125° C., surface resistances (measured without contact using the eddy current method) in the range of mOhm were achieved.

### Ink 4:

A composition was prepared from 1 g of a solution (1.28 g tris(hydroxymethyl)aminomethane and 0.86 g silver nitrate in 20 g water) and 0.253 g polyethylene oxide solution (PEO, 1 wt. % in H₂O, approx. 4,000,000 g/mol).

The composition was coated onto a PET film coated with TiO₂ and exposed to UV light at 77.25 mW/cm² for 10 minutes. After rinsing with water, a layer with a sheet resistance of 410 mOhm was obtained (measured without contact using the eddy current method). Ink 4 is in principle spinnable and areas are conductive after exposure.

### Ink 5:

A composition of 0.3 g silver acetate, 0.297 g ethanolamine and 1.010 g 1:1 mixture of polyvinylpyrrolidone solution and polyethylene oxide solution (PVP, 4 wt. %, 1,300,000 g/mol in ethanol; PEO, 2 wt. % in H₂O, approx. 4,000,000 g/mol) was prepared.

The composition was electrospun (temperature 20.8° C.; relative humidity 20%, Y-axis speed: 500 mm/s, X-axis pitch: 10 mm, pump rate 0.5 mL/h; needle/collector distance: 7 cm; voltage 10 kV, cannula diameter 0.3 mm). PC film (Makrofol DE 1-1CG) was used as the substrate. The coated substrate was then exposed to UV light twice on the Beltron UV dryer and then dried for 26 hours at 140° C. in a convection oven. The results are shown in Table 3, FIGS. 3a) and b) and FIG. 4.

Conductive samples were also obtained on glass with the ink.

TABLE 1

| | Surface | | Std. dev. | | |
|---|---|---|---|---|---|
| | resistance | Transmission | transmission | Haze | Std. dev. |
| Sample | [kOhm] | [%] | [%] | [%] | Haze [%] |
| Glass_1_1 | 0.784 | 87.1 | 1.13 | 0.96 | 0.10 |
| Glass_1_2 | 0.313 | 78.2 | 1.48 | 0.62 | 0.04 |
| PC_1_1 | 332 | 82.8 | 0.17 | 0.72 | 0.04 |

TABLE 2

| | | Surface | | Std. | | |
|---|---|---|---|---|---|---|
| | | resistance | | dev. | | Std. |
| | Surface | before | Trans- | trans- | | dev. |
| | resistance | oven | mission | mission | Haze | Haze |
| Sample | [Ohm] | [Ohm] | [%] | [%] | [%] | [%] |
| PET_2_1 | 215 | 760 | 75.5 | 0.93 | 8.31 | 1.3 |
| PET_2_2 | 197 | 260 | 73.6 | 0.97 | 8.65 | 1.25 |
| PET_2_3 | 73 | 92 | 70.4 | 1.26 | 8.66 | 0.91 |

TABLE 3

| | Surface | | Std. dev. | | |
|---|---|---|---|---|---|
| | resistance | Transmission | transmission | Haze | Std. dev. |
| Sample | [Ohm] | [%] | [%] | [%] | Haze [%] |
| PC_5_1 | — | 84.4 | 0.63 | 0.53 | 0.05 |
| (12 layers) | | | | | |
| PC_5_2 | 555 to | 83.3 | 1.01 | 0.63 | 0.08 |
| (20 layers) | plasma | | | | |
| PC_5_3 | 396 before | 80.2 | 1.36 | 0.70 | 0.10 |
| (40 layers) | plasma; 60 | | | | |
| | after | | | | |

1. Process for the production of metallic structures or surfaces comprising:
providing a composition comprising at least one metal complex or a precursor thereof, at least one reducing agent, at least one matrix material or at least one precursor thereof;
applying the composition to a substrate, whereby the application is carried out by surface contacting or application as a spun nanofiber; and
reducing the at least one metal complex to the metallic structure or surface by exposure to electromagnetic radiation and/or heating.

2. Method according to claim 1, wherein the nanofibers are obtained by electrospinning.

3. Method according to claim 1, wherein the metal complex in the composition is formed from at least one metal salt and at least one ligand.

4. Process according to claim 3, wherein the at least one ligand is a ligand with amino groups or amino and hydroxyl groups, which serve as a reducing agent in said reducing.

5. Method according to claim 1, wherein the substrate is a photocatalytically active substrate.

6. Method according to claim 1, wherein the metal complex is a silver, gold or copper complex.

7. Method according to claim 1, wherein the nanofibers have an average length of over 10 μm.

8. Coated substrate obtained by the method according to claim 1.

9. Coated substrate according to claim 8, wherein the coated substrate appears at least partially transparent.

10. Coated substrate according to claim 8, wherein the coating is conductive.

11. Coated substrate according to claim 10, wherein the coating has an anisotropic resistance.

12. (canceled)

13. A device comprising a substrate according to claim 8 as a conductor track in touch screen displays, in solar collectors, in displays, as an RFID antenna, or in transistors.
